(19) United States
(12) Patent Application Publication
(10) Pub. No.: US 2007/0220256 A1
(43) Pub. Date: Sep. 20, 2007

(54) Electronic mechanical device

(76) Inventors: Toru Yasui, Osaka (JP); Hiroyuki Nanano, Osaka (JP); Tetsuji Yamaguchi, Osaka (JP)

Correspondence Address: Kyocera Technology Development;Intellectual Property Administration, Suite 400, 1855 Gateway Blvd., Concord, CA, 94520, US

(21) Appl. No.: 11/709,980

(22) Filed: Feb. 23, 2007

(30) Foreign Application Priority Data
Mar. 20, 2006 (JP) JP2006-075859

(51) Int. Cl. H04L 9/00

(52) U.S. Cl. 713/171

(57) ABSTRACT

A method, program product, and system to provide an electronic mechanical device to reduce a network administration task in handling a communication attack. The electronic mechanical device includes an attack detection unit, a security management unit, and a communication management unit. The attack detection unit detects a communication attack through a network. The communication management unit blocks communication from an attacker device when the attack detection unit detects an attack by it. The security management unit records an expiration time for the communication block. Based on the expiration of the communication block, the block is automatically removed and the communication recovers. Also, display of network attack information and print out of the information upon detection help inform other users and can help the administrator handle a network attack faster and appropriately.

### FIELD OF THE INVENTION

The present invention relates to a technology to reduce a network management load by blocking network communication of an electronic mechanical device connected to a network which attacked the communication network, and by automatically removing the communication block after a designated time period.

### BACKGROUND OF THE INVENTION

A method for reducing an administration task for a print device connected to a network is disclosed in Japanese Patent Laid-Open 2005-193590. According to the patent publication, when a print device connected to a network is attacked through a network, the attack is detected, and the IP address of the attacker device is listed on a communication block IP address book to block the communication from the IP address.

However, this method requires the administrator to delete the IP address of the attacker device from the communication block IP address book when the attacker device recovers its normal function.

Such communication attacks are usually, induced by computer viruses. A computer virus grows on a computer and spreads the infection to numerous computers. Repairing of infected computers consume administrator's time and leave him or her no time to work on print devices and other peripheral devices.

An issue the present invention intends to address is that a network administrator has to manually delete data of an electronic mechanical device connected to the network that attacked the network from the network communication block list in order to recover communication with the device.

### SUMMARY OF THE INVENTION

An electronic mechanical device connected to a network of the present invention addresses an issue that the administrator has to manually delete data of an electronic mechanical device which attacked the network from the communication block list in order to recover the communication by simply removing the communication block upon exceeding a designated effective time period.

An electronic mechanical device connected to a network of the present invention comprises an attack detection unit which detects a communication attack through a network, a communication management unit which manages communication with the network and blocks communication with another device when the attack detection unit detects a communication attack by the device, and a security management unit which manages communication block data which is data on a communication attacker device that its communication has been blocked. The security management unit records an expiration time for the communication block on data of the communication attacker device. The communication management unit blocks communication with an attacker device, based on the communication block data, and recovers communication with the attacker upon expiration of the communication block.

These configurations contribute to reduce a network administration task. By automatically removing the communication block applied to an electronic mechanical device which attacked the network after a designated expiration time period, the administrator can be spared from manually deleting data of the attacker device from the block list.

An electronic mechanical device connected to a network of the present invention, when detects a network attack, displays information on the network attack and the attacker device on a display unit of the electronic mechanical device. Additionally, the electronic mechanical device with a print unit is able to print out attack information to inform the user on the network attack. These elements benefit the user to take an appropriate action against a network attack in a timely manner.

These and other objects, features, and advantages of the present invention are specifically set forth in or will become apparent from the following detailed descriptions of the invention when read in conjunction with the accompanying drawings.

### DESCRIPTION OF THE DRAWINGS

FIG. 1 is a function block diagram of an image forming device of the present invention.

FIG. 2 is a security policy table stored by a security management unit of the present invention.

FIG. 3 is a communication block IP address list table stored in a security management unit of the present invention.

FIG. 4 is a flowchart illustrating operation performed by a security management unit of the present invention.

FIG. 5 is a flowchart illustrating packet processing performed in an image processing device of the present invention.

### DETAILED DESCRIPTION OF THE INVENTION

Exemplary embodiments of the present invention are explained below with reference to the accompanying drawings though these embodiments are not intended to limit the invention. Additionally, in some instances, well-known structures, interfaces, and processes have not been shown in detail in order not to unnecessarily obscure the present invention.

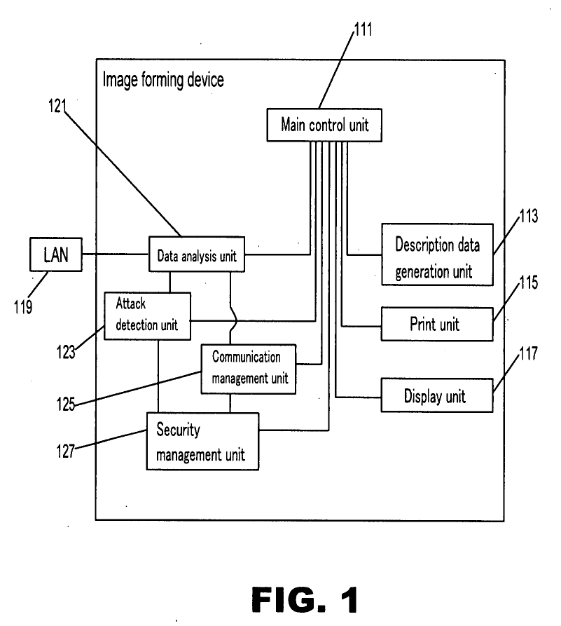

FIG. 1 is a function block diagram illustrating an embodiment of an image forming device of the present invention.

An image forming device 101 is connected with a PC (Personal Computer) of an external terminal device (not shown) through a LAN (Local Area Network) 119.

The image forming device 101 comprises a main control unit 111, a description data generation unit 113, a print unit 115, a display unit 117, a data analysis unit 121, an attack detection unit 123, a communication management unit 125, and a security management unit 127.

The main control unit 111 comprises a CPU (Central Processing Unit), a semiconductor memory, a magnetic disk, and a peripheral control circuit, and controls the each function unit, and executes each program stored therein.

The description data generation unit 113 converts print data transmitted from an external terminal device into bitmap data that can be processed by the print unit 115.

The print unit 115 comprises a printer configuration and prints out bitmap data generated by the description data generation unit 113. According to a configuration in advance, the print unit 115 can also output alert information, which is released when the attack detection unit 123 detects a network attack, and information on the attacker device.

The display unit 117 displays a status of the image forming device 101. According to a configuration in advance, the display unit 117 can also display the alert information and information on the attacker device.

The data analysis unit 121 analyzes actual data included in a received packet.

The attack detection unit 123 receives received packet data analyzed by the data analysis unit 121 and verifies authenticity of the received packet data with reference to a security policy.

The communication management unit 125 performs processing for permitting communication, with reference to communication block IP address data in the security management unit 127.

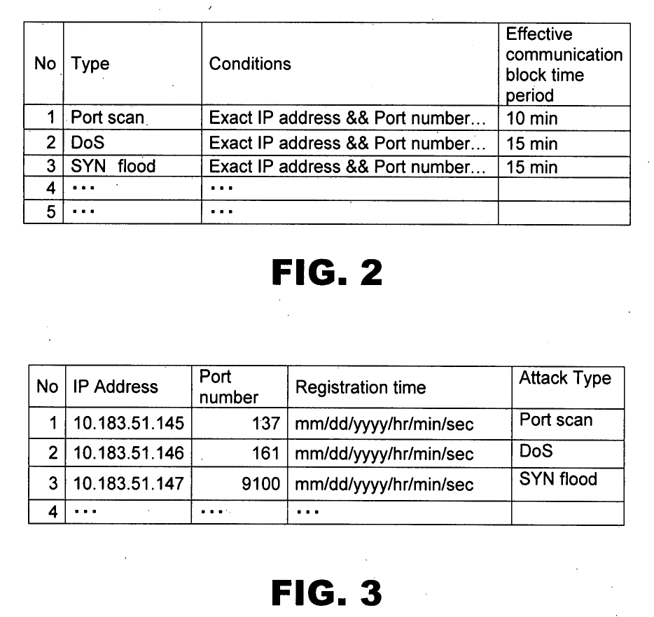

The security management unit 127 manages a security policy (FIG. 2) and a communication block IP address list (FIG. 3) which are to be described hereinafter.

FIG. 2 shows an example of the security policy.

Designated in the security policy are types of communication attack, conditions to recognize as an attack, and effective communication block time periods.

Types of communication attacks are mainly the port scan attack, the DoS (Denial of Service) attack, and the SYN (synchronous) FLOOD attack. They will be described below.

First, a port scan attack will be described.

TCP/IP (Transmission Control Protocol/Internet Protocol) communication is realized by a pair of an IP address and a port number. Various communication services are configured for each port number. Port scan attack is performed as a pre-attack search by the attacker to discover which port service is operating and for which port a firewall is active. Based on the finding from the port scan, the communication service with weak security, such as a security hole, can be continuously attacked.

Secondly, a DoS attack is a method of attack to prohibit a server from operating normally by continuously sending a large volume of unnecessary service requests and other types of packets. For example, by transmitting “GET” requests in sequence to a HTTP server, the server exhausts its memory solely by responding to the requests, and thus, the server cannot respond to other valid communication requests.

In this type of attack, since individual GET requests are valid as communication, a server cannot reject them. Therefore, close examination of sequentially received packets is required to determine their validity.

A SYN FLOOD attack is a type of the aforementioned DoS attack. It is an attack to overwhelm the server by unilaterally and continuously sending sequential request packets with the SYN bit set to establish communication. A communication connection is established by the client first sending a SYN packet to the server. The server replies with an ACK packet, and the client returning the ACK packet to the server.

In this type of attack, however, the client (attacker) transmits only the first SYN packet and never returns an ACK packet to the server as required. Therefore, wait events increases on the server end, and thereby eventually the server exhausts its resources and paralyzes its services.

In order to handle above-described attacks, the present invention analyzes received packets according to a security policy table. When determined as communication attack, they are registered to a communication block IP address list.

The security policy table includes items of attack types, conditions for attack detection, and effective communication block time periods for each attack type and condition.

An attacked device, depending on the type of attack, requires a different time period for recovery. Therefore, the present invention allows setting an individual effective communication block time period.

FIG. 3 shows a communication block IP address list table, which includes communication block data.

The communication block IP address list includes an attacker's IP address, an attacked port number, a registration time for the attacker's IP address to be registered to the block list after detection of the attack, and the attack type.

When a communication attack is detected, data on the attack will be registered to the communication block IP address list. Each piece of registered data is referred to as an “entry.”

Once listed on the communication block IP address list, a received packet with an IP address of each entry will be discarded whether or not it is of communication attack.

The communication block IP address list is monitored by the security management unit 127 for every certain period of time. Upon expiration of the effective communication block time period, specified for each attack type and conditions, which is designated in the security policy list, the blocked communication IP address will be deleted from the list.

In communication after deletion of the communication IP address, if another communication attack is detected, the IP address will be re-registered to the communication block IP address list, and a packet received from the IP address will be discarded.

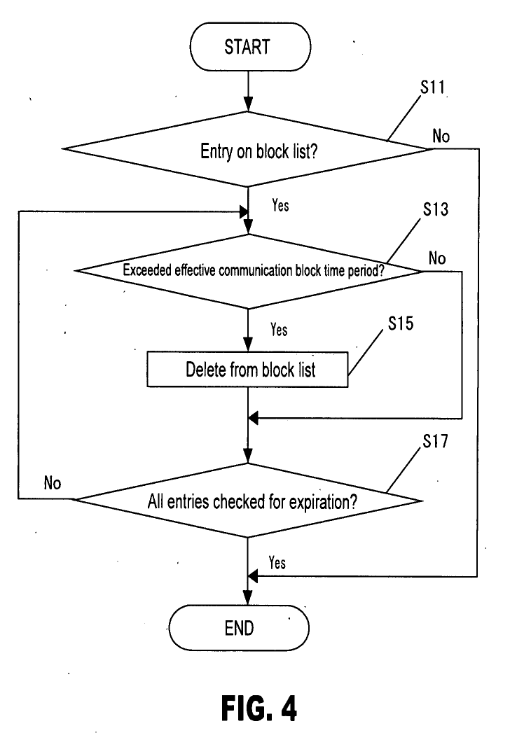

FIG. 4 is a flowchart illustrating operation of a program of the security management unit 127.

The program is activated in every certain time period (e.g. 10 seconds). The program performs deletion of a communication IP address on the communication block list managed by the security management unit 127, based on an effective communication block time period of the entry. The following describes each operation step.

In step S11, the security management unit 127 determines whether or not an IP address of the attacker device is registered as an entry to the communication block IP address list.

If the result in step S11 is “NO,” operation will be completed.

If the result in step S11 is “YES,” step S13 is executed to determine if it has exceeded the effective communication block time period. In this step, the time of the entry registered to the communication block IP address list is compared to a current time. If the difference between the time of the entry and the current time has exceeded the effective time period designated for each attack type and conditions, it is considered that the effective communication block time period has expired.

If the result in step S13 is “NO,” operation proceeds to step S17.

If the result in step S13 is “YES,” operation moves to step S15.

In step S15, the entry of which effective communication block time period was determined to have expired in step S13 is deleted from the communication block IP address list.

In step S17, it is determined whether all entries on the communication block IP address list have been checked for their expiration. If they have, the processing completes. If some entries are still on the list, they are moved up in the list, and operation returns to step S13 to repeat subsequent steps.

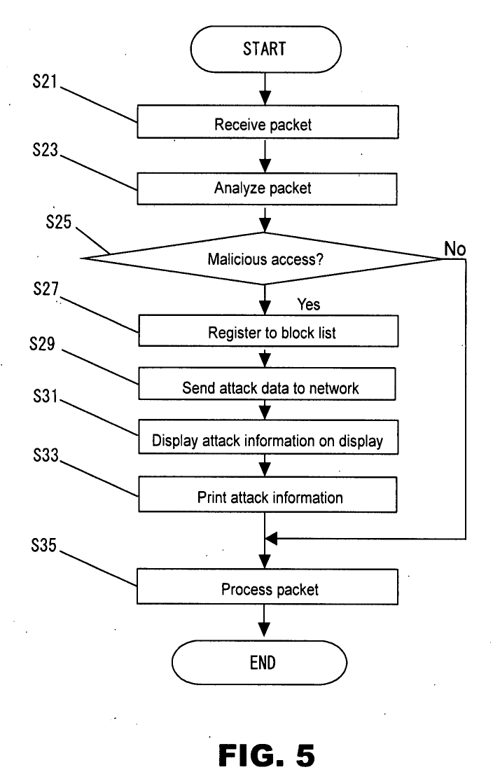

Next, operation of receiving packets performed by the image forming device 101 will be described with reference to the flowchart in FIG. 5.

In step S21, the data analysis unit 121 receives a communication packet through the network.

In step S23, the data analysis unit 121 analyzes data of the packet received in step S21.

In step S25, it is determined whether or not the packet analyzed in step S23 is of malicious nature. The access is determined to be malicious if the received packet matches the conditions defined in the security policy stored in the security management unit 127.

If the result in step S25 is “NO,” the received packet is determined as a packet of normal communication. Then, operation proceeds to step S35 to process the packet normally.

If the result in step S25 is “YES,” the received packet is determined as of communication attack, and operation proceeds to step S27.

In step S27, data of the packet determined as of communication attack in step S25 is registered to the communication block IP address list.

In step S29, data on the communication attack is sent to the network as a notification. Due to sequential packet attacks by the attacker, the notification sometimes fails to reach the network.

Therefore, in step S31, the information of the communication attack is displayed on the display unit 117 as a notification method without utilizing the server.

Similarly in step S33, as a notification method without utilizing the network, the information of the communication attack is output to the print unit 115.

In step S35, if the received packet is determined to be from the IP address registered to the communication block IP address list with reference to the block list managed by the security management unit 127, the packet is discarded and the communication is blocked.

If the received packet is from an IP address not registered to the block list, the packet is processed normally.

According to a preferred embodiment of the present invention, an image forming device which has received a communication attack can block communication from the attacker device and avoid further attacks. Additionally, the image forming device allows display of attack information on the display unit and output of the information to the print unit. By doing so, even when an attack packet monopolizes network resources during the communication attack and communication through the network is made difficult, the information displayed on the display unit and the printed information will be able to notify the user on the communication attack. Accordingly, the present invention enables appropriate and swift handling of a communication attack.

Furthermore, network attacks are usually induced by computer viruses, and handling of the attacked computers alone occupies the administrator and leaves no time for him or her to handle recovery of image forming devices and other peripheral devices. An image forming device of the present invention, however, is able to lighten the administrator's work load by allowing recovery of communication upon expiration of the designated communication block.

When the communication attack continues after removing the block, the image forming device redetects the attack and once again blocks communication from the attacker device.

A communication attack sometimes includes IP address spoofing, which involves with a forged IP address. In this attack, not only communication of the attacked device, but that of the PC and other devices to which the IP address validly allocated will also be blocked. However, with an automatic recovery method of the present invention, when requested by the user of a PC with the legitimate IP address for communication recovery (in order to transmit and output data to the image forming device with the forged IP address), the administrator can simply convey to the user that the communication will recover after a designated time period and concentrate on the main issue of recovering the attacker device.

An electronic mechanical device connected to a network, similarly to the preferred embodiments of the present invention, can be either an image forming device, or a MPF with print, facsimile, and copy functions. Alternatively, it can be a portable data terminal.

As a network identifier, in lieu of an IP address, other identifiers such as a Media Access Control (MAC) address can be used.

The present document incorporates by reference the contents of Japanese priority document, Japanese Patent Application No. 2006-075859, filed in Japan on Mar. 20, 2006.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth. There are changes that may be made without departing from the spirit and scope of the invention.

Any element in a claim that does not explicitly state “means for” performing a specific function, or “step for” performing a specific function, is not to be interpreted as a “means” or “step” clause as specified in 35 U.S.C. 112, Paragraph 6. In particular, the use of “step(s) of” or “method step(s) of” in the claims herein is not intended to invoke the provisions of 35 U.S.C. 112, Paragraph 6.

What is claimed is:

1. An electronic mechanical device connected to a network, comprising:
an attack detection unit which detects a communication attack through the network;
a communication management unit which blocks communication from another device when the attack detection unit detects a communication attack by the device; and
a security management unit which records an expiration time for the communication block on communication block data which is data on the communication attacker device,
wherein the communication management unit blocks communication from the attacker device, based on the communication block data, and recovers communication with the attacker device upon expiration of the communication block.

2. The electronic mechanical device of claim 1, wherein:
the security management unit blocks communication from the attacker device, based on a network identifier of the communication attacker device.

3. The electronic mechanical device of claim 2, wherein:
the network identifier is an IP address.

4. The electronic mechanical device of claim 1, further comprising:
a display unit which displays information on the communication attack.

5. The electronic mechanical device of claim 1, further comprising:
a print unit which prints out information on the communication attack.

6. A method for controlling communication of an electronic mechanical device connected to a network, comprising step of:
managing communication with the network;
blocking communication from another device when the attack detection unit detects a communication attack by the device;
recording an expiration time for communication block on the communication block data; and
blocking communication from the communication attacker device, based on the communication block data, and recovering communication with the communication attacker device upon expiration of the communication block.

7. The method for controlling communication of claim 6, further comprising the step of:
blocking communication from the communication attacker device, based on a network identifier of the communication attacker device.

8. The method for controlling communication of claim 7, wherein:
the network identifier is an IP address.

9. The method for controlling communication of claim 6, further comprising the step of:
displaying information on the communication attack.

10. The method for controlling communication of claim 6, further comprising the step of:
printing out information on the communication attack.

11. A storage medium having stored thereon a computer program executable for controlling communication, the program for controlling communication causing an electronic mechanical device connected to a network to perform the processing for:
managing communication with the network;
blocking communication from another device when the communication detection unit detects a communication attack by the device;
recording an expiration time for communication block on the communication block data; and
blocking communication from the communication attacker device, based on the communication block data, and recovering communication with the communication attacker device upon expiration of the communication block.

12. The storage medium of claim 11, the program for controlling communication causing the electronic mechanical device to further perform the processing for:
blocking communication from the communication attacker device, based on a network identifier of the attacker device.

13. The storage medium of claim 12, wherein: the network identifier is an IP address.

14. The storage medium of claim 11, the program for controlling communication causing the electronic mechanical device to further perform the processing for:
displaying information on the communication attack.

15. The storage medium of claim 11, the program for controlling communication causing the electronic mechanical device to further perform the processing for:
printing out information on the communication block.
